(19) United States
(12) Patent Application Publication
(10) Pub. No.: US 2024/0318762 A1
(43) Pub. Date: Sep. 26, 2024

(54) Assembly for Engaging the Interior of a Pipe

(71) Applicant: Vital Industrial Solutions Inc., Sarnia (CA)

(72) Inventors: William Ryan ARCHER, Camlachie (CA); Thomas John LANNAN, Sarnia (CA)

(73) Assignee: Vital Industrial Solutions Inc., Sarnia, ON (CA)

(21) Appl. No.: 18/675,007

(22) Filed: May 27, 2024

Related U.S. Application Data
(63) Continuation-in-part of application No. 17/930,486, filed on Sep. 8, 2022, now abandoned.
Application No. 17/930,486 is a continuation of application No. 15/733,251, filed on Jun. 17, 2020, now Pat. No. 11,460,141.
(60) Provisional application No. 62/608,152, filed on Dec. 20, 2017.

(51) Int. Cl. F16L 55/40; F16L 101/30

(52) U.S. Cl. CPC F16L 55/40; F16L 2101/30

(57) ABSTRACT

An assembly is provided for engaging inner wall of a pipe. The assembly includes end plate and annular ring coaxially aligned along a longitudinal axis of assembly, when in use. One of the end plate or annular ring includes flat portion and a flange member extending from a surface thereof and other one of the end plate or annular ring includes a beveled edge and a slot to receive flange member. A notch is defined by the flat portion, flange member and the beveled edge and a sealing member is positioned inside notch and seated on the flange member prior to assembly engaging the inner wall of pipe. An urging mechanism urges annular ring against end plate and causes flange member to be received in slot and resilient sealing member to be compressed within notch and deform radially outwardly to engage with inner wall of pipe.

### CROSS-REFERENCE TO RELATED APPLICATIONS

This application is a Continuation-in-Part of U.S. patent application Ser. No. 17/930,486 filed on Sep. 8, 2022, which is a Continuation of U.S. patent application Ser. No. 15/733,251 filed on Jun. 17, 2020, which is a National Entry of PCT Application No. PCT/CA2018/051250, filed on Oct. 3, 2018, which claims the benefit of priority to U.S. Provisional Patent Application No. 62/608,152 entitled “Assembly for Engaging the Interior of a Pipe” and filed on Dec. 20, 2017. The contents of the aforementioned applications are incorporated herein by reference as if set forth in their entirety.

### TECHNICAL FIELD

The present disclosure generally relates to an assembly for engaging the interior of a pipe and more particularly, relates to a self-centering assembly used for secure testing of welds between a pipe and a flange welded to the pipe.

### BACKGROUND

Conduits or pipe systems are commonly used in many industries, such as in petrochemical industries, for conveying fluids from one place to another. Such pipe systems are made up of one or more pipes that are connected or welded together. Generally, flanges are used to attach pipes to other pipes within the pipe system, wherein a flange is welded to a respective pipe and bolted to another flange welded to another pipe to form a seal and connect the pipes together. It is common to use flange weld testing tools to test integrity of such flange weld joints. Such testing tools operate by isolating a particular section of a pipe where the flange weld is located to test only the isolated section instead of pressurizing or flooding the entire pipeline, which can be very expensive, time consuming and overall, very inefficient.

Generally, flange weld test tools include a mandrel, a collar and a resilient sealing member coaxially provided between the mandrel and the collar. This assembly is then connected to a blind flange plate to form the flange weld test tool assembly, which in turn is inserted into the pipe to test a flange weld. The blind flange plate is bolted to the flange being tested and the resilient sealing member engages and creates a seal with the inner wall of the pipe when the tool is inserted therein. However, deploying the flange weld test tool inside the pipe can be challenging. For example, generally, components of the flange weld test tool are first coupled together loosely and inserted into the pipe. Once the tool is appropriately positioned, the blind flange plate is secured to the flange being tested and the components are tightened to seal the sealing member against the inner wall of the pipe. One issue that may be encountered with this arrangement is that when the components are loosely coupled or otherwise not engaged with the sealing member, the sealing member may shift out of alignment with respect to the other components, such as the end plate and/or the annular ring. Such misalignment can cause inconsistent sealing with the pipe, and/or may cause undue stress on the sealing member, thereby making positioning and securing of the flange weld test tool difficult.

Thus, there exists a need for an improved flange weld testing tool that addresses these issues.

### SUMMARY

In one aspect, an assembly for engaging an inner wall of a pipe is provided. The assembly includes a longitudinal axis. The assembly includes an end plate that has a flat portion provided on a surface at least on an outer perimeter thereof and a flange member extending from the surface thereof. The flat portion is on a plane perpendicular to the longitudinal axis of the assembly. The assembly further includes an annular ring coaxially aligned with the end plate along the longitudinal axis of the assembly, when the assembly is in use. The annular ring comprises a face including a slot adapted to be aligned with and receive the flange member of the end plate therein. The face of the annular ring further includes a beveled edge on an outer perimeter thereof. Further, the assembly includes a notch defined by the flange member of the end plate, the flat portion of the end plate and the beveled edge of the annular ring. A resilient sealing member is provided in the notch and seated on the flange member of the end plate prior to the assembly engaging the inner wall of the pipe. The assembly further includes an urging mechanism adapted to urge the annular ring against the end plate, whereby, when in use, the flange member of the end plate is received within the slot of the annular ring and the resilient sealing member is compressed within the notch and deformed radially outwardly to engage with the inner wall of the pipe.

In one aspect, an assembly for engaging an inner wall of a pipe is provided. The assembly includes a longitudinal axis. The assembly includes an end plate and an annular ring adapted to be coaxially aligned along the longitudinal axis of the assembly, when in use. The annular includes a face that has a flat portion provided on at least an outer perimeter thereof and a flange member extending from the face. The flat portion is on a plane perpendicular to the longitudinal axis of the assembly. The end plate comprises a surface including a slot adapted to be aligned with and receive the flange member of the annular ring therein. The surface of the end plate further includes a beveled edge on an outer perimeter thereof. Further, the assembly includes a notch defined by the flange member of the annular ring, the flat portion of the annular ring and the beveled edge of the end plate. A resilient sealing member is provided in the notch and seated on the flange member of the annular ring prior to the assembly engaging the inner wall of the pipe. The assembly further includes an urging mechanism adapted to urge the annular ring against the end plate, whereby, when in use, the flange member of the annular ring is received within the slot of the end plate and the resilient sealing member is compressed within the notch and deformed radially outwardly to engage with the inner wall of the pipe.

In another aspect, there is provided a flange weld testing tool that includes the assembly for engaging the inner wall of the pipe.

### BRIEF DESCRIPTION OF THE DRAWINGS

Embodiments will now be described with reference to the appended drawings wherein:

FIG. 1 illustrates an example assembly for engaging the interior of a pipe;

FIG. 2 illustrates an example mandrel included in the assembly of FIG. 1;

FIG. 3 illustrates an example annular ring of the assembly of FIG. 1;

FIG. 4 illustrates a rear view of a blind flange plate of the assembly of FIG. 1;

FIG. 5 illustrates an enlarged cross-sectional view of a resilient sealing member positioned between an end plate and the annular ring, of the assembly of FIG. 1, in a tightened position; and

FIG. 6 illustrates an alternative implementation of the example assembly of FIG. 1.

### DETAILED DESCRIPTION

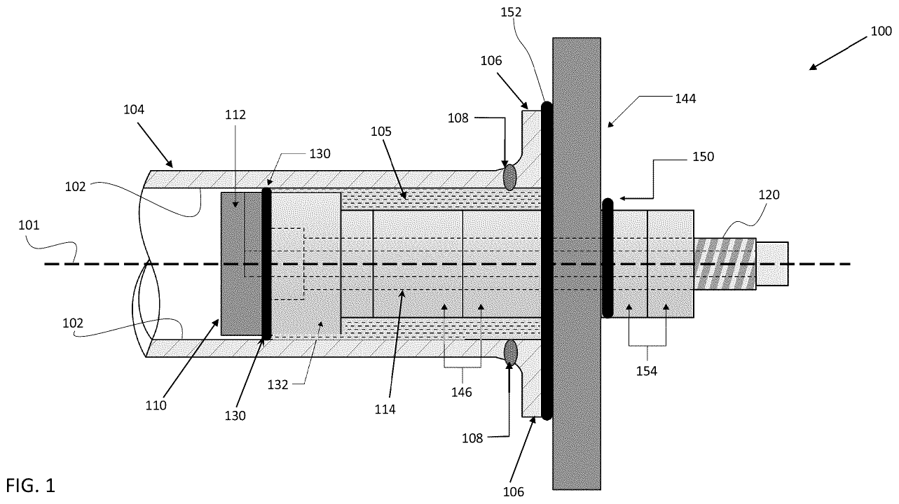

Referring now to the figures, FIG. 1 illustrates an example assembly 100 for engaging the interior, such as an inner wall 102 of a pipe 104 or any other tubular structure. In an example embodiment, a flange 106 may be secured to an end of the pipe 104 with a weld joint 108 and the assembly 100 may be used as a flange weld test tool for testing such a weld joint 108. The flange 106 may be configured to allow coupling of the pipe 104 to another pipe (not shown) by coupling to a corresponding flange, such as by bolts, which is similarly welded to the other pipe 104. In the embodiment shown in FIG. 1, when the assembly 100 is in use (as will be described later), a section 105 of the pipe 104 containing the weld joint 108 is isolated from rest of the pipe 104. The isolated section 105 is then pressurized by filling it with a testing fluid, such as water or any other fluid, that exerts pressure on the weld joints 108 to test for any leakage(s) in the weld joint 108.

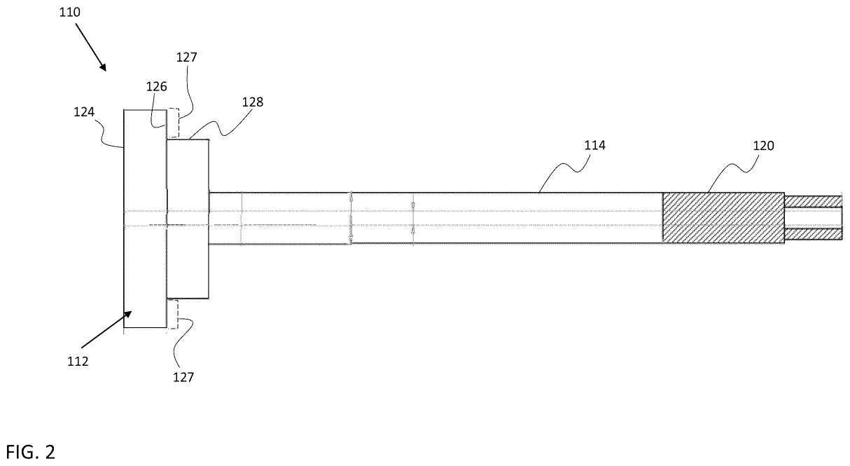

The assembly 100 includes a longitudinal axis 101 that is aligned with and parallel to a longitudinal axis (not shown) of the pipe 104, when in use. The assembly 100 includes a mandrel 110 having an end plate 112 connected at one end of a mandrel shaft 114 that extends along the longitudinal axis 101. As shown more clearly in FIG. 2, a second end of the mandrel shaft 114 includes a threaded end 120 configured to engage with a threaded fastener (not shown), such as a nut, to tighten the assembly 100 when in use.

The end plate 112 includes a first surface 124 and a second surface 126, wherein each of the first and second surfaces 124, 126, includes a respective flat portion (such as the flat portion 127 of the second surface 126), for example, at least on an outer perimeter thereof. As illustrated, the flat portions of the first and second surfaces 124, 126 are on a plane perpendicular to the longitudinal axis 101 of the assembly 100. In an embodiment, the end plate 112 includes a circumferential flange member 128, extending from the second surface 124 thereof. The flange member 128 may be perpendicular to the flat portion of the second surface 126 and, when in use, parallel to the longitudinal axis 101 of the assembly 100. The flange member 128 is configured to have a resilient sealing member 130 seated thereon, for example, when the assembly 100 is preassembled in a loose manner (as will be explained below) to provide a barrier to limit shifting of the resilient sealing member 130. In an example implementation, the resilient sealing member 130 may be embodied as an O-ring, such as a spigot ring, that seals against the inner wall 102 of the pipe 104 to isolate the section 105 from the rest of the pipe 104.

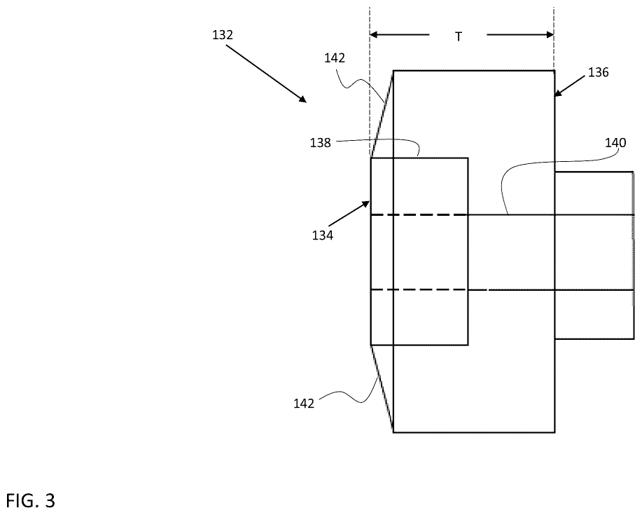

Further, the assembly 100 includes an annular ring 132, such as a collar, coaxially aligned with the end plate 112 along the longitudinal axis 101 of the assembly 100, when the assembly 100 is in use. The annular ring 132 is supported on the mandrel shaft 114. As shown in FIG. 3, the annular ring 132 includes opposed faces, namely, a first face 134 and a second face 136 defining a thickness T thereof. In one embodiment, the first face 134 of the annular ring 132 includes a slot 136 that is complementary to the flange member 128 of the end plate 112. The slot 138 extends at least partially through the thickness T of the annular ring 132 and is configured to align with and receive the flange member 128, for example, when the assembly 100 is in use. The annular ring 132 further includes a second slot 140 extending through the thickness T to receive the mandrel shaft 114 therein. The slot 138 is configured to surround the second slot 140, which in turn surrounds the mandrel shaft 114. In an embodiment, the first face 134 of the annular ring 132 includes a beveled edge 142 on the outer perimeter thereof. The beveled edge 142 is configured to receive and interact with the resilient sealing member 130 and cooperate with the flat portion 127 and the flange member 128 to direct the deformation of the resilient sealing member 130 radially outwardly into engagement with the inner wall 102 of the pipe 104. Although the present disclosure describes having the flange member 128 and the flat portion 127 on the end plate 112 and having the slot 138 and the beveled edge 142 on the annular ring 132, in some alternative implementations, they can be switched. That is, in some implementations, the end plate 112 may include beveled edge 142 and the slot 138 whereas the flange member 128 and the flat portion 127 may be provided on the annular ring 132 instead. Further, while the flange member 128 and the slot 138 in this example are shown as continuous circumferential members, multiple discontinuous flange members, posts or other members having various shapes or contours (with corresponding slots to receive same) could also be used without departing from the principles discussed herein.

The flat portion 127, the flange member 128 and the beveled edge 142 define a notch in which the resilient sealing member 130 is positioned. The assembly 100 may be configured to accommodate various sizes and dimensions of the resilient sealing member 130. For instance, a bigger sealing member may occupy the entire space within the notch whereas a smaller sealing member may only partially occupy the space within the notch. In an embodiment, when the assembly is preassembled in a loose manner, the flange member 127 is received within the slot 138 of the annular ring 132 to have the resilient sealing member 130 seated thereon and between the flat portion 127 and the opposing beveled edge 142. This way, the flange member 128 provides a sliding barrier to maintain axial alignment and prevent the resilient sealing member 130 from falling in the gap between the end plate 112 and the annular ring 132, when the assembly 100 is preassembled to be inserted into the pipe 104.

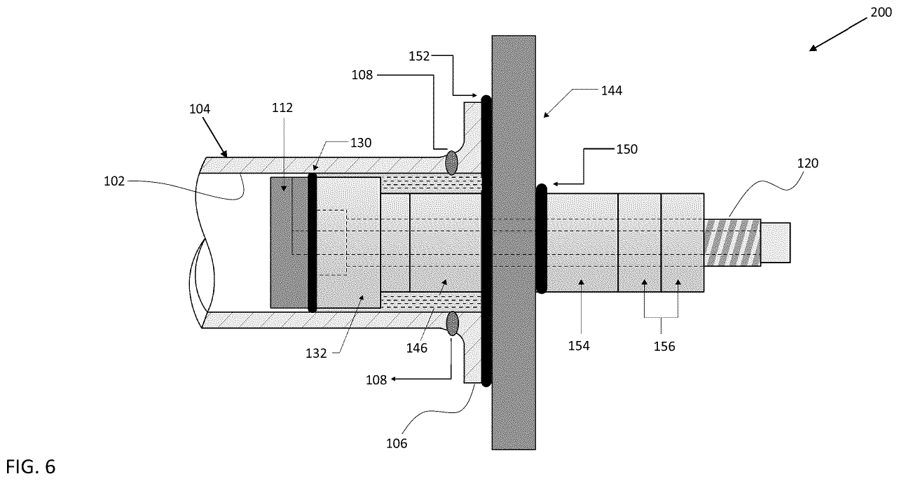

The mandrel 110 including the end plate 112 and the shaft 114 with the resilient sealing member 130 and annular ring 132 mounted thereon is then installed on a blind flange plate 144. In some implementations, one or more spacers 146 may additionally be installed on the mandrel shaft 114 prior to installation on the blind flange plate 144. The spacers 146 may be configured to adjust a distance between the resilient sealing member 130 and the blind flange plate 144 to generate the desired length of the isolated section 105. In an example implementation, spacers 146 may be solid blocks of desired thickness, such as 1 inch, 2 inches, and so on. For example, to reduce the length of the isolated section and have the resilient sealing member 130 close to the plate 144, only a single spacer 146, such as a 2 inch spacer, may be used (as shown in FIG. 6). Similarly, to achieve a higher length of the isolated section 105, the distance between the blind flange plate 144 and the resilient sealing member 130 can be increased by adjusting the number and size of the spacers 146. In the example shown in FIG. 1, two spacers 146, of 2 inches thickness each, are used to have a higher distance between the blind flange plate 144 and the resilient sealing member 130 as compared to that of the example shown in FIG. 6. In an embodiment, the assembly 100 may be configured to adapt to vary a distance within a range of 2 to 7 inches between the blind flange plate 144 and the resilient sealing member 130.

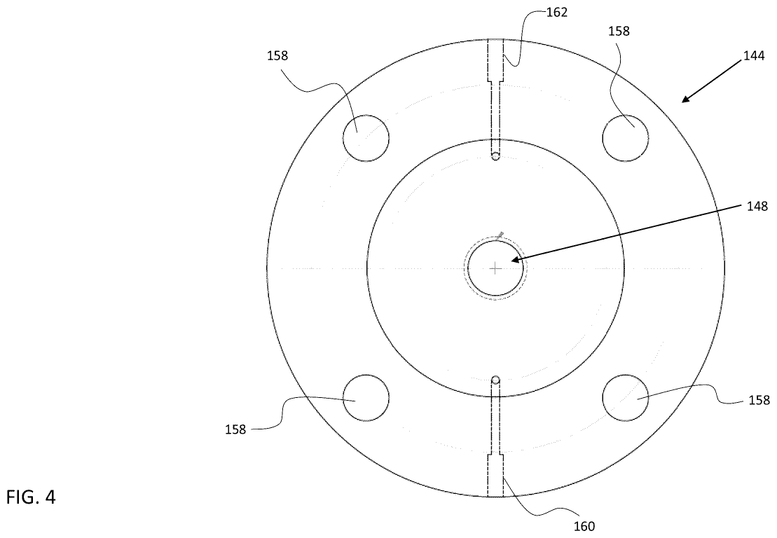

As shown more clearly in FIG. 4, the blind flange plate 144 includes a central receptacle 148 configured to receive the threaded end 120 of the mandrel shaft 114 therethrough. A corresponding threaded fastener (not shown) is then engaged and loosely fastened to the threaded end 120 to preassemble the assembly 100 in a loose manner, i.e., prior to entering the assembly 100 into the pipe 104. In some implementations, as shown in FIG. 1, the blind flange plate 144 also includes a first outer seal 150 and a second outer seal 152 provided on the opposing faces thereof. The first outer seal 150 is configured to interact with and seal against the threaded fastener when engaged with the threaded end 120 of the mandrel shaft 114 (or one or more spacers, as will be explained below), whereas the second outer seal 152 is configured to seal against the flange 106 when the assembly 100 is in use.

In some implementations, additional spacers, such as outer spacers 154 shown in FIGS. 1 and 6, may be supported on the mandrel shaft 114 before installing the threaded fastener to accommodate the desired distance between the plate 144 and the resilient sealing member 130 with respect to the total length of the shaft 114. For example, as shown in FIG. 6, if the distance between the blind flange plate 144 and the sealing member 130 is reduced (i.e., only a single 2 inch spacer is used between them), the corresponding non threaded portion of the shaft 114 extending beyond the blind flange plate 144 may use one or more outer spacers 154 to ensure proper positioning and engagement of the threaded end 120 with the threaded fastener. In the example shown in FIG. 6, the assembly 200 includes one 2-inches outer spacer 154 and two 1 inch outer spacers 156 to accommodate for the reduced distance between the blind flange plate 144 and the resilient sealing member 130. In such cases, the first outer seal sits between the outer spacer 154 and the blind flange plate 144. As will be understood, the assembly 200 shown in FIG. 6 is similar to the assembly 100 shown in FIG. 1 with the only difference in the number and positioning of spacers 146 and 154. Thus, all the other reference numerals shown in FIG. 6 are kept consistent with those of FIG. 1.

Further, as shown in FIG. 4, the blind flange plate 144 includes a number of holes 158 that may be circumferentially and equidistantly spaced and adapted to align with corresponding holes (not shown) provided on the flange 106 of the pipe 104. As the assembly 100 is inserted into the pipe 104, the blind flange plate 144 engages with the flange 106 such that the holes 158 are aligned with the respective holes on the flange 106 to receive corresponding fasteners for coupling the blind flange plate 144 and the flange 106 together. As the blind flange plate 144 interfaces and is coupled to the flange 106, the second outer seal 152 abuts and seals against the surfaces of the plate 144 and the flange 106 to provide a leak proof coupling.

Further, the blind flange plate 144 includes a first or fill port 160 that may be in communication with a quick coupler (not shown) that can be in turn connected to a medium in order to introduce the testing fluid through the ports 160 into the isolated section 105. The blind flange plate 144 further includes a second or gauge port 162 that can be connected to a pressure gauge to monitor the pressure inside the isolated section 105 and establish and verify the seals made by the resilient sealing member 130 and the seal 152 to ensure the intended isolation is maintained throughout the operation. In an example implementation, as illustrated, the first port 160 and the second port 162 opposite to one another, such as at 6 o'clock and 12 o'clock positions, respectively.

In operation, the assembly 100 is first preassembled and loosely coupled together outside the pipe 104. In pre-assembling the components, the resilient sealing member 130 is coaxially provided on the mandrel 110 followed by the annual ring 132 such that the flange member 128 is received into the slot 138 of the annular ring 132 and the resilient sealing member 130 is seated in the notch defined by the flat portion 127, the flange member 128 and the beveled edge 142. In such a configuration, the flange member 128 provides a barrier and prevents the resilient sealing member 130 from falling in the gap and thus maintains the axial alignment of the resilient sealing member 130 with respect to the rest of the assembly 100 in the pre-assembled state. This is followed by installing the spacers 146, as desired, and then coupling this assembly to the blind flange plate 144. The assembly 100 is held together by loosely fastening the threaded fastener to the threaded end 120 of the mandrel shaft 114.

The pre-assembled assembly 100 is then inserted into the pipe 104 until the blind flange plate 144 engages with the flange 106 that needs to be tested. The blind flange plate 144 is secured to the flange 106 by aligning the holes 158 on the plate 144 with the respective holes on the flange 106 and receiving corresponding fasteners, such as bolts, nuts, and washers, therethrough. As will be appreciated, the threaded end 120 of the mandrel shaft 114 and the holes 158 provided on the blind flange plate 144 cooperate as an urging mechanism to urge the components of the assembly 100 together when the assembly 100.

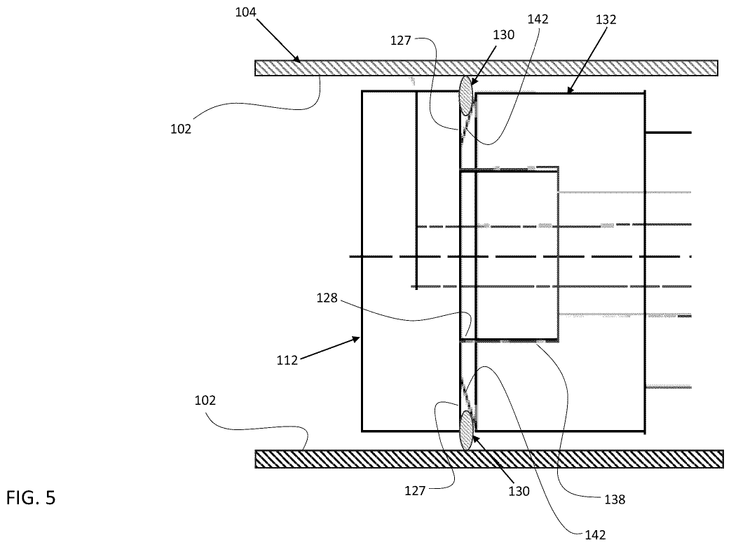

Once the assembly 100 is appropriately positioned in place, all the fasteners, including the threaded fastener engaged with the threaded end 120 of the mandrel shaft 114 and the fasteners engaged in the holes 158, are then tightened, thereby urging all elements of the assembly 100 together. As shown in FIG. 5, as the fasteners are tightened, the annular ring 132 is urged against the end plate 112 and the flange member 128 slidingly enters into the slot 138 of the annular ring 132 thereby causing a compressive force on the resilient sealing member 130 positioned within the notch. As the resilient sealing member 130 is compressed, the opposing flat portion 127 and the beveled edge 142 cause a radially expansive force on the sealing member 130, thereby directing it to expand only radially outwardly and engage with the inner wall 102 of the pipe 104. The notch, including the flange member 128, the flat portion 127 and the beveled edge 142 also prevents uneven expansion of the resilient sealing member 130 without the need to necessarily torque the fasteners in a particular sequence. Furthermore, a maximum torque may be implemented to avoid damaging the threads, the flange member 128, or other components of the assembly 100. This also makes the assembly 100 easy to use without any extensive training.

Once all the components of the assembly 100 are tightened, the isolated section 105 is filed and pressurized up to a desired with the testing fluid (via the first port 160) to test the strength and integrity of the weld joint 108. Once the testing is complete, the section 105 is depressurized and the assembly 100 is unfastened and removed from the pipe 104.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

Although the above principles have been described with reference to certain specific examples, various modifications thereof will be apparent to those skilled in the art as outlined in the appended claims.

1. An assembly for engaging an inner wall of a pipe, the assembly having a longitudinal axis and comprising:
an end plate including a flat portion provided on a surface at least on an outer perimeter thereof and a flange member extending from the surface thereof, the flat portion being on a plane perpendicular to the longitudinal axis of the assembly;
an annular ring coaxially aligned with the end plate along the longitudinal axis of the assembly, when in use, the annular ring comprising a face including a slot adapted to be aligned with and receive the flange member of the end plate therein, wherein the face of the annular ring has a beveled edge on an outer perimeter thereof;
a notch defined by the flange member of the end plate, the flat portion of the end plate, and the beveled edge on the face of the annular ring;
a resilient sealing member provided in the notch and seated on the flange member of the end plate prior to the assembly engaging the inner wall of the pipe; and
an urging mechanism adapted to urge the annular ring against the end plate, whereby, when in use, the flange member of the end plate is received within the slot of the annular ring and the resilient sealing member is compressed within the notch and deformed radially outwardly to engage with the inner wall of the pipe.

2. The assembly of claim 1 further comprising a mandrel shaft extending along the longitudinal axis of the assembly and connected at a first end to the end plate, the mandrel shaft being adapted to support the annular ring and the resilient sealing member thereon.

3. The assembly of claim 2, wherein the urging mechanism includes a threaded end provided at a second end of mandrel shaft and adapted to engage with a threaded fastener.

4. The assembly of claim 1, wherein the pipe includes a flange attached to one end of pipe with a weld joint and wherein the resilient sealing member engages with the inner wall of the pipe to isolate a section of the pipe containing the weld joint.

5. The assembly of claim 1 comprising a blind flange plate adapted to engage with a flange attached to the pipe, wherein the blind flange plate comprising:
one or more circumferentially spaced holes for aligning with respective holes provided on the flange attached to the pipe; and
a central receptacle adapted to receive a mandrel shaft connected at one end to the end plate and to a threaded fastener at a second end.

6. The assembly of claim 5, wherein the urging mechanism includes the one or more circumferentially spaced holes aligned with the respective holes provided on the flange attached to the pipe and a number of respective fasteners received and engage through the aligned holes.

7. The assembly of claim 5, wherein the blind flange plate includes one or more ports for directing a testing fluid into the pipe.

8. The assembly of claim 5, further comprising one or more outer seals positioned between the blind flange plate and the flange attached to the pipe when the blind flange plate engages with the flange.

9. The assembly of claim 1, wherein the flange member of the end plate is provided as a circumferential flange extending from the surface of the end plate.

10. The assembly of claim 1, wherein the resilient sealing member is an O-ring.

11. The assembly of claim 1 comprising:
a mandrel shaft connected at one end to the end plate; and
one or more spacers supported on the mandrel shaft, the one or more spacers being coaxially aligned with the end plate and the annular ring along the longitudinal axis of the assembly.

12. A flange weld testing tool comprising the assembly of claim 1.

13. An assembly for engaging an inner wall of a pipe, the assembly having a longitudinal axis and comprising:
an end plate and an annular ring adapted to be coaxially aligned along the longitudinal axis of the assembly, when in use;
the annular ring comprising a face having a flat portion provided at least on an outer perimeter thereof and a flange member extending from the face, the flat portion being on a plane perpendicular to the longitudinal axis of the assembly;
the end plate comprising a surface including a slot adapted to be aligned with and receive the flange member of the annular ring therein, wherein the surface of the end plate includes a beveled edge on an outer perimeter thereof;
a notch defined by the flange member of the annular ring, the flat portion of the annular ring, and the beveled edge on the surface of the end plate;
a resilient sealing member provided in the notch and seated on the flange member of the annular ring prior to the assembly engaging the inner wall of the pipe; and
an urging mechanism adapted to urge the annular ring against the end plate, whereby, when in use, the flange member of the annular ring is received within the slot of the end plate and the resilient sealing member is compressed within the notch and deformed radially outwardly to engage with the inner wall of the pipe.

14. The assembly of claim 13 further comprising a mandrel shaft extending along the longitudinal axis of the assembly and connected at a first end to the end plate, the mandrel shaft being adapted to support the annular ring and the resilient sealing member thereon.

15. The assembly of claim 14, wherein the urging mechanism includes a threaded end provided at a second end of mandrel shaft and adapted to engage with a threaded fastener.

16. The assembly of claim 13 comprising a blind flange plate adapted to engage with a flange attached to the pipe, wherein the blind flange plate comprising:
one or more circumferentially spaced holes for aligning with respective holes provided on the flange attached to the pipe; and
a central receptacle adapted to receive a mandrel shaft connected at one end to the end plate and to a threaded fastener at a second end.

17. The assembly of claim 16, wherein the urging mechanism includes the one or more circumferentially spaced holes aligned with the respective holes provided on the flange attached to the pipe and a number of respective fasteners received and fastened through the aligned holes.

18. The assembly of claim 13, wherein the flange member of the annular ring is provided as a circumferential flange extending from the face of the annular ring.

19. The assembly of claim 13 comprising:
a mandrel shaft connected at one end to the end plate; and
one or more spacers supported on the mandrel shaft, the one or more spacers being coaxially aligned with the end plate and the annular ring along the longitudinal axis of the assembly.

20. A flange weld testing tool comprising the assembly of claim 13.
